(19) United States
(12) Patent Application Publication
(10) Pub. No.: US 2019/0352868 A1
(43) Pub. Date: Nov. 21, 2019

(54) IMPROVED ROAD PROTECTION BARRIER

(71) Applicant: Jose Manuel Sanchez De La Cruz, Castelldefels (ES)

(72) Inventor: Jose Manuel Sanchez De La Cruz, Castelldefels (ES)

(21) Appl. No.: 16/476,139

(22) PCT Filed: Jan. 3, 2018
(86) PCT No.: PCT/ES2018/070002

§ 371 Date: Jul. 5, 2019

(30) Foreign Application Priority Data
Jan. 5, 2017 (ES) P201730013

(51) Int. Cl. E01F 9/30; E01F 15/08; G08B 7/06

(52) U.S. Cl. CPC E01F 9/30; G08B 7/06; E01F 15/08

(57) ABSTRACT

The barrier is of the type formed by a flexible or compact impact absorbing structure, in which inner or outer ducts are defined for the passage of cables having various functions, such as power supply, sensing, signaling and/or communication with a central traffic control unit, with the particularity that various barrier units are grouped to form a segment (4) that determines the lower level of a hierarchical distribution system with different autonomous and independent levels, providing a grid controlled by a data receiving, transmitting and managing central unit, in such a way that each segment (4) comprises an independent controller (8) comprising an electric power supply socket for the segment and a wireless communication module (9), ensuring the integrity of the grid, both horizontally, i.e. within the same level, thus avoiding any physical interruption to the transmission of signals, and vertically, i.e. hierarchically within the system.

### FIELD OF THE INVENTION

The present invention relates to a series of improvements introduced in patents WO2011/015678 and WO 2014/113520, of which this applicant is the owner, related to road protection barriers.

The object of the invention is to provide a barrier, based on which it is possible to form a grid for sensing, monitoring and transferring data throughout different roadways, in such a way that if one section of the barrier is disabled, either due to an accident, substitution or vandalism, the communication system formed by the assembly of barriers is not affected.

### BACKGROUND OF THE INVENTION

As was mentioned in the previous section, this applicant is the owner of registered documents WO2011/015678 and WO 2014/113520, in which road protection barriers are described which have as a common denominator the fact that they have a flexible structure to allow for specific impacts to be absorbed, said barriers having inner chambers or spaces especially designed for channeling cables intended for different functions, such as sensing as well as signaling and for communication with a central traffic control unit.

Now, although these types of barriers satisfactorily comply with the function for which they were designed, as is obvious, the arrangement thereof on the roads on which they are implemented can lead to interruptions, meaning it is not continuous, either due to the existence of on-ramps, junctions, etc., which prevents the continuity of the cables housed inside the same.

Likewise, there is another problem related to the impact of a vehicle against the barrier, which, based on the severity of the same, could even cut the cables, interrupting communications, resulting in the same situation that occurs in the case of sabotage by vandals, or when the barrier is being replaced during maintenance operations.

Thus, the sensing/signaling grid, and the data transfer through the barriers described in registered documents WO2011/015678 and WO 2014/113520 has specific problems with regard to the continuity in the signal transmission, which would be desirable to solve.

### SUMMARY OF THE INVENTION

The improved road protection barrier contemplated solves the previously mentioned problem in a completely satisfactory way.

To do so, it is envisaged that the grid formed from these types of barriers is divided and subdivided into independently hierarchical sections that are related to each other, forming with the same an autonomous system in which the upper levels are not affected when there is a failure in a lower level.

More specifically, it is envisaged that in ascending manner in said hierarchy, the following is defined:
Various barrier units form a segment.
Various segments form a group.
Various groups form a sector.
Various sectors form a section.
Various sections determine a road.
Various roads make up a grid.
Etc.

Each road could likewise be divided into traffic directions, or even lanes that participate in the same and which are assisted by the barrier system object of the invention.

To do so, each level that participates in the system will have transmitters and receivers, from which signals are received from or transmitted to hierarchically upper or lower levels thereof, such that each section, segment, etc., likewise transmits or receives the information from the central unit or from the user and is autonomously powered, at least having a self-powered transmitter/receiver.

Thus, each level can be continuously powered by a conventional power plant, through the corresponding registration, and/or by small power plants powered by conventional energy capture systems, such as solar panels, wind mills, batteries, etc., or each set of units can have an autonomous power system, according to the needs thereof.

Likewise, each element that participates in each level will have wireless communication means through which continuity will be provided to the grid, both in a horizontal direction, meaning within the same level, thereby circumventing any physical interruption in the signal transmission, and a vertical direction, meaning hierarchical.

With respect to the lowest level, the transmitters of the barriers will be connected to the sensors they have, such as impact, temperature, rain, fog and proximity sensors, video cameras and lights, etc., as well as to the corresponding warning elements, such as screens, luminous danger signals, position and signaling lights, microphones, speakers, holographic, virtual reality and 3D vision projections, etc.

This way, the information will be managed hierarchically until reaching the corresponding central unit, thereby obtaining a highly efficient and flexible system.

As a result, and from said structuring, it is ensured that the lack of electric power or data in a barrier section, either due to an involuntary act, such as an accident, or a voluntary act (sabotage/vandalism or maintenance) does not affect the rest of the system formed from said barriers.

### BRIEF DESCRIPTION OF THE DRAWINGS

As a complement to the description that will be provided herein, and for the purpose of helping to make the features of the invention more readily understandable, according to a preferred practical exemplary embodiment thereof, said description is accompanied by a drawing constituting an integral part thereof in which, by way of illustration and not limitation, the following is represented:

FIG. 1 shows a plan view of a section of road in which a plurality of road protection barriers has been implemented according to the object of the invention, showing how several barrier units form a segment, with the corresponding sensors, electrical power and signal transmission cables thereof being independent among segments, guaranteeing continuity in the system in the case of a failure of one of said segments or one of the barriers that participate in the same.

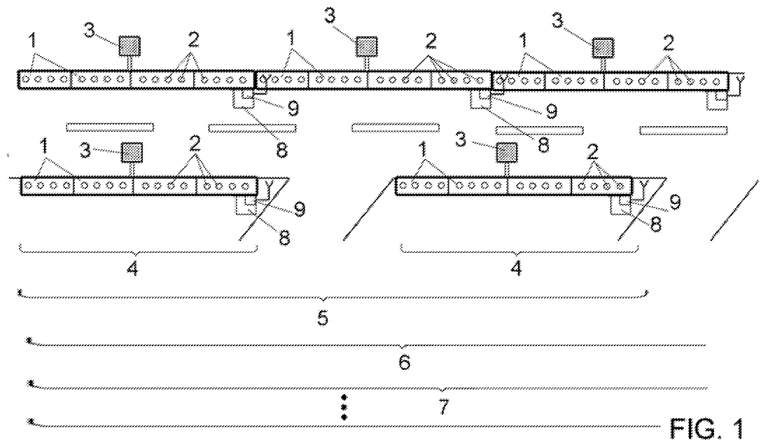

### DETAILED DESCRIPTION OF THE INVENTION

In light of the FIGURE, one can see how the improved road protection barrier of the invention is based on the conventional structure of any type of protection barrier, such as those described in documents WO2011/015678 and WO 2014/113520, meaning it is formed as a barrier (1), in which a flexible or compact impact-absorbing structure participates, wherein inner or outer ducts are defined for the passage of the cables intended for different functions, such as electric power, sensing, signaling and communication with other devices and/or central units for receiving, transmitting and managing data, the barrier having electrical or electronic devices (2) of any type, such as impact, temperature, rain, fog and proximity sensors, video cameras, lights, etc., as well as warning elements (3) such as luminous signals indicating accidents and danger, screens, position and signaling lights; the same being able to be integrated in LED screens or similar lighting technology; in addition to other warning elements such as microphones, speakers, holographic, virtual reality and 3D vision projections, and similar.

From this structure, it is envisaged that various barrier units are grouped to form a segment (4) that determines the lower level of the system, the system being hierarchically distributed into different autonomous and independent levels, such that, for example, various segments (4) form one group (5), various groups (5) form one sector (6), various sectors (6) form a segment (7), various segments form a road, and various roads form a grid, each road able to likewise be divided into traffic directions, or even lanes that participate in the same and which are assisted by the barrier system object of the invention.

Now, the autonomy of the segments (4) is achieved by assigning an independent controller (8) to each of the segments (4), wherein an electric power supply is included for the segment, either from a conventional power plant, through the corresponding registration, or from small power plants powered by conventional energy capture systems, such as solar panels, wind mills, batteries, etc.

Likewise, in said controller (8) a wireless communication module (9) will be established, such as by means of radio frequencies, through which continuity will be provided to the grid, both in a horizontal direction, meaning within the same level, thereby circumventing any physical interruption in the signal transmission, and a vertical direction, meaning in the previous described hierarchy.

This way, each level that participates in the system will have transmitters and receivers, from which they will transmit or receive signals to and from the hierarchically upper or lower levels thereof, such that each section, segment, etc. likewise transmits or receives the information to and from the central unit or the user, autonomously, such that, for example, a warning may be issued at a certain distance in advance by means of the barrier system of the presence of an accident, fog, or any other event that requires precaution, even if there is a physical discontinuity between the barrier section in which the event is detected with respect to the barrier section which is intended to warn the drivers of said event.

Each controller (8) will have at least an identification code, which can be individual or shared, according to each case.

These controllers (8) can, if necessary, exchange information with any of the other controllers (8) of any other hierarchical segment, if necessary, skipping over upper or lower levels according to each case.

The devices (2) as well as the warning elements (3) can be electrically autonomous and can also carry the transmitters and receivers as necessary, to directly communicate with the corresponding controllers (8).

All of this information managed by the central units can be received by authorized vehicles, which carry the compatible transmitters and receivers for such purpose.

The controllers (8) can carry a GPS geolocation module or similar for the location thereof, as well as transmit several radio frequency signals for different uses.

1-7. (canceled)

8. A road protection impact-absorbing barrier system comprising:
a plurality of barrier units coupled together to form a segment that defines a lower level of a hierarchical distribution system, wherein a plurality of segments is coupled together to define a higher level of the hierarchical distribution system so that different autonomous and independent levels are created defining a grid controlled by a central unit receiving, transmitting and managing data, each barrier unit incorporating:
at least one electrical device and at least one warning element associated with an impact detection and notification system;
at least one independent controller with a power source for said segment; and
a wireless communication module to communicate between different segments and hierarchical levels of the hierarchical distribution system.

9. The road protection impact-absorbing barrier system of claim 8, wherein the power source of said at least one independent controller is provided by one of: a utility power grid, a solar panel, a wind mill and a battery.

10. The road protection impact-absorbing barrier system of claim 8, wherein the at least one electrical device and the at least one warning element are autonomously powered and further comprise transmitters and receivers.

11. The road protection impact-absorbing barrier system of claim 8, wherein said at least one independent controller exchanges information with independent controllers of other segments on the same hierarchical level, on a higher hierarchical level or on a lower hierarchical level of the hierarchical distribution system.

12. The road protection impact-absorbing barrier system of claim 8, wherein said at least one controller has an identification code.

13. The road protection impact-absorbing barrier system of claim 8, further comprising communication means for communicating with authorized vehicles carrying transmitters and receivers compatible with the road protection impact-absorbing barrier system.

14. The road protection impact-absorbing barrier system of claim 8, wherein said at least one controller further comprises a geolocation module.
